(19) United States
(12) Patent Application Publication
(10) Pub. No.: US 2026/0064550 A1
(43) Pub. Date: Mar. 5, 2026

(54) AI-Assisted Project Proposal Generation Triggered By Changes In Prompt-Referenced Datasets

(71) Applicant: Oracle International Corporation, Redwood Shores, CA (US)

(72) Inventors: Vineela Sesh Mannepalli, Hyderabad (IN); Veda Sruthi Bondada, San Jose, CA (US); Pyay Aung San, San Francisco, CA (US); Jeffrey Thomas Colvard, San Mateo, CA (US); Yogendra Swami, Hyderabad (IN); Forrest Elliott, Burien, WA (US); Alexander Nathan Lederman, Seattle, WA (US); Ajit Kumar Das, Hyderabad (IN); Sravan Maringanti, Hyderabad (IN); Peter Weiss, Golden, CO (US); Alasdair John Joseph Bailey, Perth (GB); Caitlin Moran, Seminole, FL (US); Sripranav Kumar Muktevi, Hyderabad (IN)

(73) Assignee: Oracle International Corporation, Redwood Shores, CA (US)

(21) Appl. No.: 19/185,202

(22) Filed: Apr. 21, 2025

Related U.S. Application Data
(60) Provisional application No. 63/690,963, filed on Sep. 5, 2024.

(51) Int. Cl. G06F 11/30

(52) U.S. Cl. CPC G06F 11/3037

(57) ABSTRACT

Techniques for triggering regeneration of content by a generative AI model based on changes to stored data are disclosed. A system inputs a prompt to a generative AI model to generate content based on a target data set stored at a memory location. The system monitors the target data set to detect changes to the target data set. Responsive to detecting changes to the target data set, the system triggers the generative AI model to generate updated content based on the updated version of the target data set that is currently stored at the memory location. For example, in the context of project proposal generation, when details such as scope, timelines, or budget are updated to the underlying dataset, the system automatically regenerates the proposal content using a generative AI model. This enables organizations to deliver timely, accurate, high-quality proposals to prospective customers, increasing the likelihood of winning deals.

### BENEFIT CLAIMS; RELATED APPLICATIONS; INCORPORATION BY REFERENCE

This application claims the benefit of U.S. Provisional Patent Application 63/690,963, filed Sep. 5, 2024, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to a triggering mechanism for the application of a generative Artificial Intelligence (AI) model. In particular, the present disclosure relates to monitoring stored data referenced by generative AI prompts for a project proposal to detect changes that trigger the generative AI model for regeneration of the project proposal.

### BACKGROUND

Project proposals provide decision-makers with information about why a project is important, how it would be carried out, and a timeline for carrying out the project. Currently, project managers face a time-consuming task of manually identifying sources of information, collecting the information, and presenting the information in a persuasive and organized way in a project proposal. During the project proposal phase, several factors-such as evolving client requirements, stakeholder feedback, resource availability, market conditions, and internal constraints—can dynamically impact timelines, budgets, and scope. As a result, project managers often struggle to ensure that proposals reflect the most up-to-date and relevant information. Continuous monitoring of these variables is essential, and the ability to adapt proposals in real time is critical for maintaining accuracy and alignment with current conditions.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIGS. 1A and 1B illustrates a system in accordance with one or more embodiments;

FIG. 2 illustrates an example set of operations for monitoring stored data used in a generative AI prompt to detect a trigger to regenerate a project proposal in accordance with one or more embodiments;

FIGS. 3A-3C illustrate an example embodiment; and

FIG. 4 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. GENERATIVE AI TRIGGER ARCHITECTURE
3. GENERATIVE MODELS
4. TRIGGERING OF GENERATIVE AI MODEL BASED ON CHANGES TO STORED DATA
5. INDUSTRIAL APPLICATIONS
6. EXAMPLE EMBODIMENT
7. COMPUTER NETWORKS AND CLOUD NETWORKS
8. HARDWARE OVERVIEW
9. MISCELLANEOUS; EXTENSIONS

### 1. General Overview

One or more embodiments configure the automatic triggering of a generative artificial intelligence (AI) model based on changes detected in a data set that is used by the generative AI model to generate content. Initially, the system inputs a prompt to the generative AI model to generate content based on a target data set. The prompt may specifically identify the target data set and/or identify a memory location that stores the target data set. Subsequent to generation of the content by the generative AI model, the system monitors the target data set to detect changes to the target data set. Detecting the changes may include, for example, periodically retrieving a current version of the target data set and comparing the current version of the target data set to a prior version of the target data set. In another example, detecting the changes may include monitoring write operations associated with the memory location that stores the target data set. Detecting changes may be referred to herein as detecting changes that meet one or more criteria for updating the content.

Responsive to detecting changes to the target data set, the system triggers the generative AI model to generate updated content based on the updated version of the target data set that is currently stored at the memory location. Triggering the generative AI model to generate updated content may, for example, include re-inputting a prompt to the generating AI model that references the memory location where the target data set is stored. Triggering the generative AI model to generate updated content may, for example, include generating a new prompt to the generating AI model that references the updated version of the target data set or a memory location where the updated version of the target data set is stored.

A generative AI prompt may define a data type or a data attribute(s) for selecting a dataset to be input to the generative AI model. The system identifies a target set of records or files that match the data type or data attributes defined by a generative AI prompt. The system may periodically or continuously execute a query to identify datasets to include in the target set of records or files to be monitored. If the changes to the identified datasets meet one or more triggering criteria, the system re-executes the generative AI model.

One or more embodiments regenerate portions of a prior output of a generative AI model that correspond to modified datasets. In an example, the system executes a generative AI model to generate a project proposal. The system instructs the generative AI model to identify the datasets used for respective portions of the project proposal. Furthermore, the system monitors each of the datasets used for respective portions of the project proposal. In response to detecting that a dataset used for a particular portion of the project proposal has been modified, the system instructs the generative AI model to replace the particular portion of the project proposal with new content that corresponds to a current version of the dataset.

One or more embodiments described in this Specification and/or recited in the claims may not be included in this General Overview section.

### 2. Generative AI Trigger Architecture

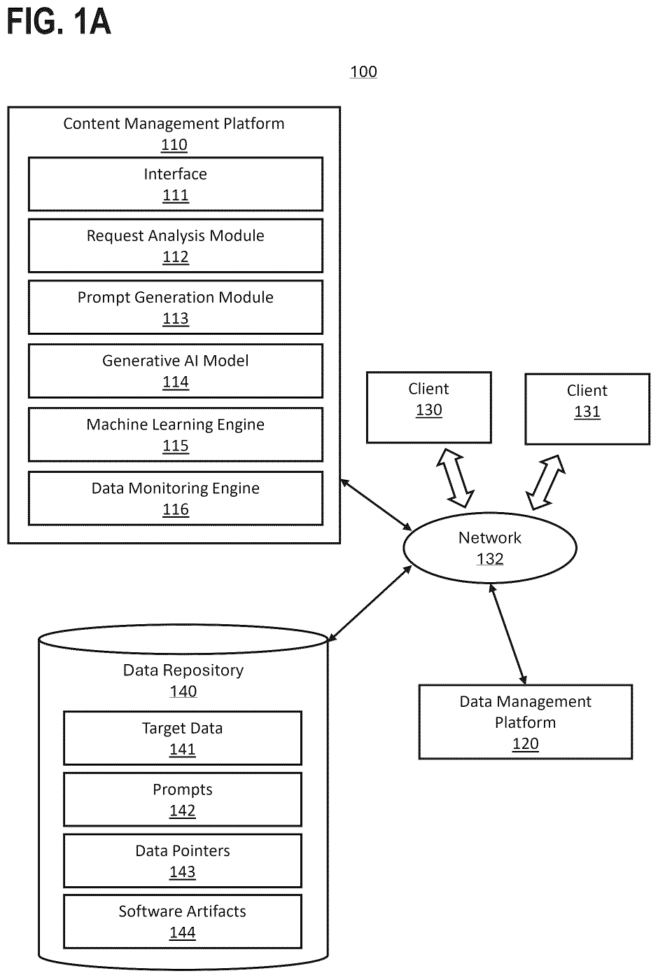

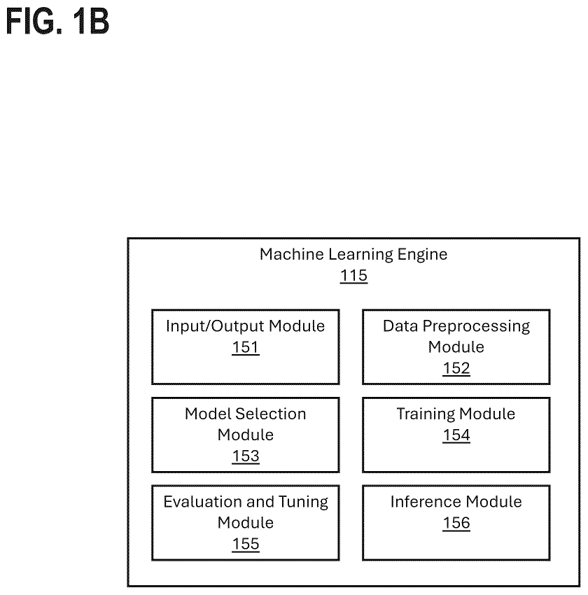

FIG. 1A illustrates a system 100 in accordance with one or more embodiments. As illustrated in FIG. 1A, system 100 includes a content management platform 110, a data management platform 120, clients 130 and 131, and a data repository. In one or more embodiments, the system 100 may include more or fewer components than the components illustrated in FIG. 1A. The components illustrated in FIG. 1A may be local to or remote from each other. The components illustrated in FIG. 1A may be implemented in software and/or hardware. Each component may be distributed over multiple applications and/or machines. Multiple components may be combined into one application and/or machine. Operations described with respect to one component may instead be performed by another component.

Additional embodiments and/or examples relating to computer networks are described below in Section 7, titled “Computer Networks and Cloud Networks.”

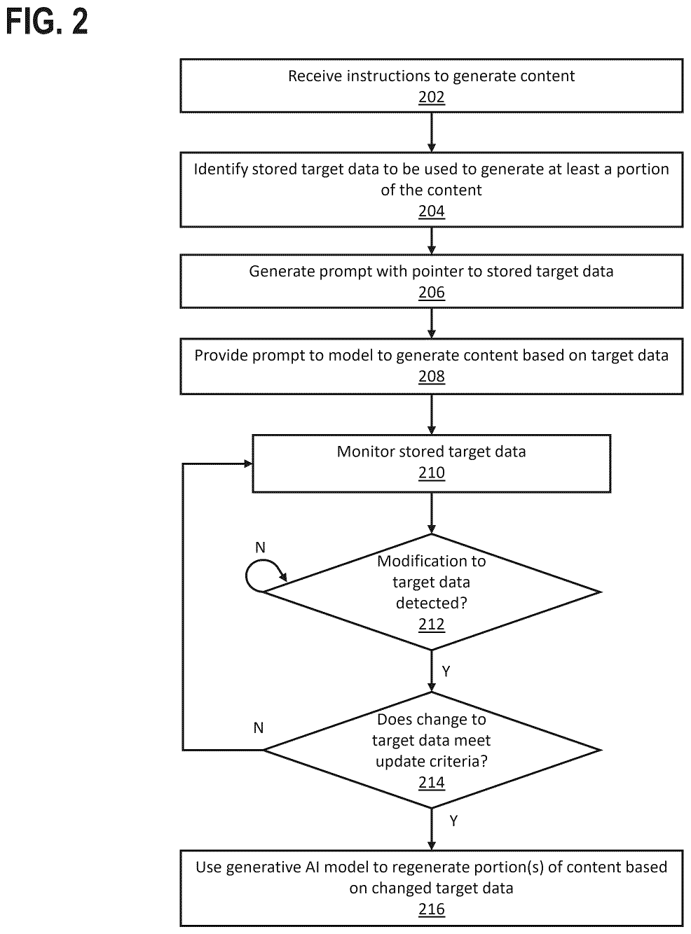

In one or more embodiments, content management platform 110 refers to hardware and/or software configured to perform operations described herein for triggering a generative AI model 114 to regenerate content based on detecting changes to stored data used to generate previously-generated content. Examples of operations for triggering a generative AI model 114 based on changes to stored data are described below with reference to FIG. 2.

In an embodiment, content management platform 110 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, and a mainframe.

In one or more embodiments, a data repository 140 is any type of storage unit and/or device (e.g., a file system, database, collection of tables, or any other storage mechanism) for storing data. Further, a data repository 140 may include multiple different storage units and/or devices. The multiple different storage units and/or devices may or may not be of the same type or located at the same physical site. Further, a data repository 140 may be implemented or executed on the same computing system as the content management platform 110 or the data management platform 120. Additionally, or alternatively, a data repository 140 may be implemented or executed on a computing system separate from the content management platform 110 or the data management platform 120. The data repository 140 may be communicatively coupled to the content management platform 110 or the data management platform 120 via a direct connection or via a network 132.

Information describing target data 141, prompts 142, data pointers 143, and software artifacts 144 may be implemented across any of components within the system 100. However, this information is illustrated within the data repository 140 for purposes of clarity and explanation.

A client 130 interacts in an interface 111 to generate a request. The request includes instructions for a generative AI model 114 to generate content. The request may include a pointer to, or description of, data to be used by the generative AI model 114 to generate the content.

In one or more embodiments, interface 111 refers to hardware and/or software configured to facilitate communications between a user and the content management platform 110. Interface 111 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms. In an embodiment, the content management platform 110 transmits display data to client 130 to display a GUI on a display device associated with the client 130. A user interacts with interface elements in the GUI to generate requests for a generative AI model 114 to generate content in software artifacts 144, such as documents, forms, and webpages. The client device 130 displays the documents, forms, and webpages on the display device of the client 130.

In an embodiment, different components of interface 111 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, interface 111 is specified in one or more other languages, such as Java, C, or C++.

A request analysis module 112 analyzes incoming requests to determine if the requests include reference to stored data. The request may include a document or file attached to the request. Alternatively, the request may include a Unform Resource Locator (URL) or memory address that point to stored data.

A prompt generation module 113 generates a prompt 142 to the generative AI model 114. The prompt includes instructions for generating content. The prompt 142 also includes a data pointer 143 to data to be used to generate content. For example, the data pointer 143 may be URL or memory address that point to the target data 141 associated with the request.

Target data 141 includes data describing a system, an organization, an application, markets, projects, or individuals. A system may include, for example, a computing system or computing environment. In one embodiment, the stored target data includes stored project data. Stored project data includes customer or client data associated with a customer or client identified in the request. In the above example, the system identifies one or more data files, tables, or other data structures that store data about ABC Co. Customer data may include data for an enterprise's existing customer. Alternatively, customer data may include data for a potential customer. In an example where the customer data includes data for a potential customer, the project proposal may be a pitch proposal. An entity may use a generative AI model 114 to create a pitch to a potential client to offer goods or services to the potential client.

Stored project data further includes product data, workflow data, personnel data, and other data associated with project proposals. Product data may include product specifications, sales data, customers that purchase and/or use a product, and market data associated with the product. Workflow data includes processes implemented by a company to complete projects. For example, a company may implement a product rollout by following a sequence of operations, including development, product testing, consumer demand analysis, marketing, rollout initiation, and customer follow-up. The operations may include a set of defined tasks performed by individuals, teams, and organizations within the company. Workflow data may include company-defined workflows and historically implemented workflows.

Personnel data includes data describing personnel in an organization. For example, the personnel data may specify a number of teams that participate in product development, statistics measuring team performance, and scheduling data for employees, teams, and organizations, such as availability data and lead time required to schedule a set of employees to perform a task.

In one or more embodiments, project data includes historical data specifying historical project proposals, historical proposed timelines to perform tasks, and historical outcomes of the project proposals. Examples of historical outcomes include the success or failure of the project proposal and the success or failure of approved projects.

In one or more embodiments, project data includes electronically stored data, including tables, charts, graphs, text content, data files, image type files, word processing type files, and data objects.

In one or more embodiments, project data includes past project proposals. The system may identify past project proposals that have been approved for implementation and/or successfully implemented. Examples of past project proposal data include metrics such as project success rates.

In one or more embodiments, the target data 141 includes data describing a system (e.g., system data), such as computing device in a network and other network characteristics. Examples of system data include a number and type of computing devices, characteristics of the computing devices (e.g., processing capacity, memory capacity, functionality), applications running on computing devices, resource requirements of the applications, efficiency, utilization, and processing capacity of computing devices, bandwidth, latency, and other attributes of network components.

FIG. 1B illustrates an example of a machine learning engine 115 according to one or more embodiments. As illustrated in FIG. 1B, machine learning engine 115 includes input/output module 151, data preprocessing module 152, model selection module 153, training module 154, evaluation and tuning module 155, and inference module 156.

In accordance with an embodiment, input/output module 151 serves as the primary interface for data entering and exiting the system by managing the flow and integrity of data. This module may accommodate a wide range of data sources and formats to facilitate integration and communication within the machine learning architecture.

In an embodiment, an input handler within input/output module 151 includes a data ingestion framework capable of interfacing with various data sources, such as databases, A Pls, file systems, and real-time data streams. This framework is equipped with functionalities to handle different data formats (e.g., CSV, JSON, X machine learning) and efficiently manage large volumes of data. It includes mechanisms for batch and real-time data processing that enable the input/output module 151 to be versatile in different operational contexts, whether processing historical datasets or streaming data.

In accordance with an embodiment, input/output module 151 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 151 includes an output framework designed to handle the distribution and exportation of outputs, predictions, or insights. Using the output framework, input/output module 151 formats these outputs into user-friendly and accessible formats, such as reports, visualizations, or data files compatible with other systems. Input/output module 151 also ensures secure and efficient transmission of these outputs to end-users or other systems in an embodiment and may employ encryption and secure data transfer protocols to maintain data confidentiality.

In accordance with an embodiment, data preprocessing module 152 transforms data into a format suitable for use by other modules in machine learning engine 115. For example, data preprocessing module 152 may transform raw data into a normalized or standardized format suitable for training machine learning models and for processing new data inputs for inference. In an embodiment, data preprocessing module 152 acts as a bridge between the raw data sources and the analytical capabilities of machine learning engine 115.

In an embodiment, data preprocessing module 152 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through various methods, such as imputation or removal of incomplete records, depending on the nature and volume of the missing data. Data preprocessing module 152 may be configured to handle anomalies in different ways depending on context. Data preprocessing module 152 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 152 includes a feature encoding framework that ensures categorical variables are transformed into a format that can be easily interpreted by machine learning algorithms. Techniques, like one-hot encoding or label encoding, may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 152 processes new data for inference, data preprocessing module 152 replicates the same preprocessing steps to ensure consistency with the training data format. This helps to avoid discrepancies between the training data format and the inference data format, thereby reducing the likelihood of inaccurate or invalid model predictions.

In an embodiment, model selection module 153 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 153 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 153 utilizes techniques from the field of Automated Machine Learning (A utomachine learning). A utomachine learning systems automate the process of model selection by rapidly prototyping and evaluating multiple models. They use different techniques, like Bayesian optimization, genetic algorithms, or reinforcement learning, to explore the model space efficiently. Model selection module 153 may use these techniques to evaluate each candidate model based on performance metrics relevant to the task. For example, accuracy, precision, recall, or F1 score may be used for classification tasks, and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, for it represents a smaller average discrepancy between the actual and predicted values.

In accordance with an embodiment, model selection module 153 also considers computational efficiency and resource constraints. This is meant to help ensure the selected model is both accurate and practical in terms of computational and time requirements. In an embodiment, certain features of model selection module 153 are configurable such as a configured bias toward (or against) computational efficiency.

In accordance with an embodiment, training module 154 manages the ‘learning’ process of machine learning models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 154 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 154 manages overfitting, where a model learns the training data too well, including its noise and outliers, at the expense of its ability to generalize to new data. Techniques, such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 154 includes logic to handle different types of data and learning tasks. For instance, it includes different training routines for supervised learning (where the training data comes with labels) and unsupervised learning (without labeled data). In the case of deep learning models, training module 154 also manages the complexities of training neural networks that include initializing network weights, choosing activation functions, and setting up neural network layers.

In an embodiment, evaluation and tuning module 155 incorporates dynamic feedback mechanisms and facilitates continuous model evolution to help ensure the system's relevance and accuracy as the data landscape changes. Evaluation and tuning module 155 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 155 performs continuous model tuning by using hyperparameter optimization. Evaluation and tuning module 155 performs an exploration of the hyperparameter space using algorithms, such as grid search, random search, or more sophisticated methods like Bayesian optimization. Evaluation and tuning module 155 uses these algorithms to iteratively adjust and refine the model's hyperparameters-settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and tuning module 155 integrates data feedback and updates the model. Evaluation and tuning module 155 actively collects feedback from the model's real-world applications, an indicator of the model's performance in practical scenarios. Such feedback can come from various sources depending on the nature of the application. For example, in a user-centric application, such as a recommendation system, feedback might comprise user interactions, preferences, and responses. In other contexts, like predicting events, it might involve analyzing the model's prediction errors, misclassifications, or other performance metrics in live environments.

In an embodiment, feedback integration logic within evaluation and tuning module 155 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 155 employs version control mechanisms to track changes, modifications, and the evolution of the model, facilitating transparency and allowing for rollback, if necessary. This continuous learning and adaptation cycle, driven by real-world data and feedback, helps to endure the model's ongoing effectiveness, relevance, and accuracy.

In an embodiment, inference module 156 transforms data raw data into actionable, precise, and contextually relevant predictions. In addition to processing and applying a trained model to new data, inference module 156 may also include post-processing logic that refines the raw outputs of the model into meaningful insights.

In an embodiment, inference module 156 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 156 transforms the outputs of a trained model into definitive classifications. Inference module 156 employs the underlying model as a tool to generate probabilistic outputs for each potential class. It then engages in an interpretative process to convert these probabilities into concrete class labels.

In an embodiment, when inference module 156 receives the probabilistic outputs from the model, it analyzes these probabilities to determine how they are distributed across some, or every, potential class. If the highest probability is not significantly greater than the others, inference module 156 may determine that there is ambiguity or interpret this as a lack of confidence displayed by the model.

In an embodiment, inference module 156 uses thresholding techniques for applications where making a definitive decision based on the highest probability might not suffice due to the critical nature of the decision. In such cases, inference module 156 assesses if the highest probability surpasses a certain confidence threshold that is predetermined based on the specific requirements of the application. If the probabilities do not meet this threshold, inference module 156 may flag the result as uncertain or defer the decision to a human expert. Inference module 156 dynamically adjusts the decision thresholds based on the sensitivity and specificity requirements of the application subject to calibration for balancing the trade-offs between false positives and false negatives.

In accordance with an embodiment, inference module 156 contextualizes the probability distribution against the backdrop of the specific application. This involves a comparative analysis, especially in instances where multiple classes have similar probability scores, to deduce the most plausible classification. In an embodiment, inference module 156 may incorporate additional decision-making rules or contextual information to guide this analysis, ensuring that the classification aligns with the practical and contextual nuances of the application.

In regression models, where the outputs are continuous values, inference module 156 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 156 incorporates domain-specific adjustments into its post-processing routine. This involves tailoring the model's output to align with specific industry knowledge or contextual information. For example, in financial forecasting, inference module 156 may adjust predictions based on current market trends, economic indicators, or recent significant events, ensuring that the outputs are both statistically accurate and practically relevant.

In an embodiment, inference module 156 includes logic to handle uncertainty and ambiguity in the model's predictions. In cases where inference module 156 outputs a measure of uncertainty, such as in Bayesian inference models, inference module 156 interprets these uncertainty measures by converting probabilistic distributions or confidence intervals into a format that can be easily understood and acted upon. This provides users with both a prediction and an insight into the confidence level of that prediction. In an embodiment, inference module 156 includes mechanisms for involving human oversight or integrating the instance into a feedback loop for subsequent analysis and model refinement.

In an embodiment, inference module 156 formats the final predictions for end-user consumption. Predictions are converted into visualizations, user-friendly reports, or interactive interfaces. In some systems, like recommendation engines, inference module 156 also integrates feedback mechanisms, where user responses to the predictions are used to continually refine and improve the model, creating a dynamic, self-improving system.

In an embodiment, input/output module 151 receives a dataset intended for training. This data can originate from diverse sources, like databases or real-time data streams, and in varied formats, such as CSV, JSON, or X machine learning. Input/output module 151 assesses and validates the data, ensuring its integrity by checking for consistency, data ranges, and types.

In an embodiment, training data is passed to data preprocessing module 152. Here, the data undergoes a series of transformations to standardize and clean it, making it suitable for training machine learning models. This involves normalizing numerical data, encoding categorical variables, and handling missing values through techniques like imputation.

In an embodiment, prepared data from the data preprocessing module 152 is then fed into model selection module 153. This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 154 trains the selected model with the prepared dataset. It implements learning algorithms to adjust the model's internal parameters, optimizing them to identify patterns and relationships in the training data. Training module 154 also addresses the challenge of overfitting by implementing techniques, like regularization and early stopping, ensuring the model's generalizability.

In some embodiments, the training module 154 iteratively applies the machine learning algorithm to a set of input data to generate an output set of labels, compares the generate labels to pre-generated labels associated with the input data, adjusts weights and offsets of the algorithm based on an error, and applies the algorithm to another set of input data. In some cases, the training module 154 may generate and train a candidate recurrent neural network model such as a long short-term memory (LSTM) model. With recurrent neural networks, one or more network nodes or “cells” may include a memory. A memory allows individual nodes in the neural network to capture dependencies based on the order in which feature vectors are fed through the model. The weights applied to a feature vector representing one feature may depend on its position within a sequence of feature vector representations. Thus, the nodes may have a memory to remember relevant temporal dependencies between different sets of input features.

In some embodiments, the training module 154 compares the labels estimated through the one or more iterations of the machine learning model algorithm with observed labels to determine an estimation error. The training module 154 may perform this comparison for a test set of examples, which may be a subset of examples in the training dataset that were not used to generate and fit the candidate models. The total estimation error for a particular iteration of the machine learning algorithm may be computed as a function of the magnitude of the difference and/or the number of examples for which the estimated label was wrongly predicted.

In some embodiments, the training module 154 determines whether or not to adjust the weights and/or other model parameters based on the estimation error. Adjustments may be made until a candidate model that minimizes the estimation error or otherwise achieves a threshold level of estimation error is identified. In some embodiments, the training module 154 selects machine learning model parameters based on the estimation error meeting a threshold accuracy level. For example, the system may select a set of parameter values for a machine learning model based on determining that the trained model has an accuracy level for predicting labels of at least 98%.

In an embodiment, evaluation and tuning module 155 evaluates the trained model's performance using the validation dataset. Evaluation and tuning module 155 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 151 receives a dataset intended for inference. Input/output module 151 assesses and validates the data.

In an embodiment, data preprocessing module 152 receives the validated dataset intended for inference. Data preprocessing module 152 ensures that the data format used in training is replicated for the new inference data, maintaining consistency and accuracy for the model's predictions.

In an embodiment, inference module 156 processes the new data set intended for inference, using the trained and tuned model. It applies the model to this data, generating raw probabilistic outputs for predictions. Inference module 156 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

Referring to FIG. 1A, a data monitoring engine 116 monitors the target data 141 to detect changes to the target data 141. The target data 141 may be managed by a data management platform 120. According to an example, the data management platform 120 includes a database server, and the target data 141 is stored in a database. The data management platform 120 may include applications accessible by clients 130 and 131 to access target data 141 and other stored data. Client 131 may access and modify target data 141 via the data management platform 120. The data monitoring engine 116 monitors the target data 141 to detect modifications.

In an embodiment, the content management platform 110 stores prompts 142 generated by the prompt generation module 113 and data pointers 143 included in the prompts. The data monitoring engine 116 may follow the data pointers 143 to access and monitor the target data 141. According to one example, the data monitoring engine 116 periodically retrieves a current version of the target data 141 and compares the current version of the target data 141 to a prior version of the target data. In another example, the data monitoring engine monitors write operations executed by the data management platform 120 associated with the memory location that stores the target data 141.

In an embodiment, the data monitoring engine 116 detects a user request to access a software artifact 144 that was generated using target data 141. The data monitoring engine 116 may initiate operations to identify changes to the target data 141 based on detecting the user request to access the software artifact 144.

### 3. Generative Models

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks, such as unsupervised learning, semi-supervised learning, and domain adaptation.

One type of generative model is a large language model (LL M). Large language models (LLM s) are designed to understand, generate, and interpret human language by processing extensive collections of data. The foundational architecture behind LLMs is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a SoftMax function to obtain the weights for the value vectors. The scaled dot-product attention function is applied independently by each head in the multi-head, self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 151, when used for LLMs, handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text after generating predictions or responses.

In accordance with one or more embodiments, data preprocessing module 152 in the context of LLM s may include a step, like normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 153, when used for LLM s, involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 154, when used for LLMs, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware, such as Graphics Processing Units (GPUs) or Tensor Processing Units (TPUs), to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 155 assesses the performance of LLM s using various metrics, such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 156, in the context of LLMs, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). An LMM is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for numerous applications, such as image captioning, text-to-image generation, image-to-text generation, visual question answering, and more, where understanding the relationship between different data types is crucial. By leveraging diverse datasets during training, large multimodal models (LMMs) learn to create coherent and contextually relevant outputs across various modalities, enhancing their utility in complex, real-world scenarios.

The architecture of LMMs combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of LMMs. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In LMMs, data preprocessing is a step that ensures the input data is in a suitable format for the model to process. This involves tasks, such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training LMMs involves optimizing their parameters through exposure to diverse datasets that include paired data from different modalities. This computationally intensive process often requires specialized hardware, like GPUs or TPUs, to manage the large volumes of data and the complexity of the model calculations. Techniques, such as dropout and layer normalization, are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of LMMs are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides LLM s and LMM s belong to the broad category of generative models. For example, stochastic models directly incorporate randomness into their structure, making them inherently generative as they can produce a diverse set of outputs for a given input. Using a dual-network architecture that involves a generative component, Generative Adversarial Networks (GANs) learn to generate new data that is indistinguishable from the data they were trained on. Variational A utoencoders (VAEs) are explicitly designed for generating new data points by learning a distribution of the input data and encoding inputs into a latent space and generating outputs by sampling from this space, making them inherently generative. Sequence-to-sequence models are generative in nature when used with sampling strategies. Although this list of generative model types is not exhaustive, it illustrates the broad use of the term generative model beyond LLM s.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 4. Triggering of Generative AI Model Based on Changes to Stored

FIG. 2 illustrates an example set of operations for triggering the application of a generative AI model based on changes to monitored datasets in accordance with one or more embodiments. One or more operations illustrated in FIG. 2 may be modified, rearranged, or omitted all together. Accordingly, the particular sequence of operations illustrated in FIG. 2 should not be construed as limiting the scope of one or more embodiments.

A system receives instructions to generate content using a generative AI model (Operation 202). The instructions may include natural language instructions for the generative AI model to generate content. In one or more embodiments, the instructions are received by a generative AI model interface platform that receives instructions to the generative AI model and determines whether or not to modify the instructions and/or add content to the instructions prior to transmitting the instructions to the generative AI model in a generative AI prompt.

In one example, the system may generate the instructions based on a user interaction with an interface element of a graphical user interface (GUI). A user may select an interface element to generate a set of text or to generate an image. Based on the user's selection of the interface element, the system generates a set of instructions including instructions for the generative AI model to generate content. In another example, a sales manager and a project manager may engage in online communications about a new sales opportunity. The system may apply a semantic content analysis model to the conversation to identify content associated with generating a new project proposal. The system may present the interface element in the GUI concurrently with displaying the conversation. The project manager may interact with the interface element to generate a new project proposal. The system may extract content from the conversation to generate the project proposal.

The system identifies stored target data to be used to generate at least a portion of the content indicated in the instructions (Operation 204). Examples of stored data include data describing a system, an organization, an application, markets, projects, or individuals. In one embodiment, the stored target data includes stored project data.

The instructions for generating content may specify the stored data. For example, the instructions may include the following: “Using the sales data located at [address], generate a paragraph describing . . . ” Alternatively, the instructions may specify a data type, such as “sales data.” The system may analyze contextual information in the instructions to identify the particular sales data to be used to generate content. For example, the instructions may include the following: “Using sales data for Product X in the past quarter, generate a paragraph describing . . . ” The system parses the request to identify the terms “sales data” “Product X” and “past quarter.” The system identifies the stored data that meets the criteria. Identifying the stored data may include, for example, executing a database query. Additionally, or alternatively, identifying the stored data may include traversing an enterprises data storage system to identify data nodes, such as folders or files, that match the description of the target data.

In one example embodiment, the system identifies a set of data required to generate content by generating a preliminary prompt for a generative AI model. The preliminary prompt may include the received instructions, with an additional instruction to: “Identify a set of data that would be required to execute this instruction.” The generative AI model may generate an output that describes a set of data, such as “data describing the workloads of processing nodes in the network between January and March.” The system may then analyze system logs to identify the stored data specified by the generative AI model as being required to generate requested content.

The system generates a generative AI prompt that includes a pointer to a location in memory of the target data (Operation 206). The pointer may include an address or digital pointer, such as a uniform resource locator (URL), that directs a computer to a storage location of the target data. The system may generate multiple pointers to multiple different locations where target data is stored. In some embodiments, the system attaches one or more digital files to a generative AI prompt. The generative AI prompts includes (a) instructions to generate particular content and (b) the pointer to the target data stored in memory.

In some embodiments, the generative AI prompt includes template data specifying standardized information to be included in generated content. An example of standardized information to be included in generated content includes standardized heading information, a standardized amount of information to be generated, a set of standardized information (such as a standardized system or organization summary), and standardized chart, graph, or image types.

In some embodiments, the generative AI prompt includes static content with pointers to dynamic content. Static content includes template data and data instructing the generative AI model to generate content with defined characteristics, such as defined section headers of a defined length. The dynamic content may change over time. Accordingly, providing the same prompt text including the same static content and the same pointers to a generative AI model at two different times may result in the generative AI model generating different content with the same structure.

The system provides the generative AI prompt to a generative AI model to generate requested content (Operation 208). The generative AI model generates the requested content based on structural and grammatical patterns learned during training and further based on the target data pointed to by one or more pointers in the generative AI prompt. In one or more embodiments, the generative AI model generates content that describes trends, objectives, scope, timelines, estimates, and predictions associated with target data.

In one embodiment, the generative AI prompt includes a pointer to an example of content in a requested format. For example, the generative AI prompt may request that the generative AI prompt generate a set of software code or a software artifact. When processed by a display processor, the software artifact may be displayed as a webpage, a document, or an image. The pointer may point to an example of a webpage, document, or image with a desired structure. The generative AI model may generate content in the desired structure with data based on the target data.

In one or more embodiments, the generative AI model generates content that identifies critical components in a set of target data. For example, the generative AI model may identify data values that have a relationship with an overall success or failure of a project, an application, or a system.

In some embodiments, a user may modify portions of the content generated by the generative AI model. A user may add or remove sections, text, and images. A user may generate follow-up requests to cause the system to generate follow-up generative AI prompts to generate additional content, such as charts and graphs, to modify verbiage, and to modify projections. The system stores the modifications as target data. The system may include the modifications in subsequent prompts to the generative AI model for generating content.

In some embodiments, the generative AI model generates recommendations for a system based on target data. In addition, the generative AI model may generate recommendations for modifying the structure of presented content. For example, the generative AI prompt may include software artifact template data including a set group of sections to be presented based on executing the software artifact. The generative AI model may generate a recommendation based on stored software artifact presentation data to add a risk management section to the presented software artifact data. Based on detecting a selection to accept the recommendation, the generative AI model may generate a prediction, using stored target data, associated with system risks and recommendations for mitigating the system risks.

Subsequent to generating the content, the system monitors the stored target data for modifications to the stored target data (Operation 210). Modifications may include adding, deleting, and modifying values in the target data. For example, if the target data includes data describing an organization, the system monitors the target data to detect changes in organization data, such as revenue values, cost values, profitability values, production values, efficiency values, sales data, price data, organizational structure, staffing and employment changes, and changes to physical plant data. As another example, if the target data describes a computing system, such as a cloud services environment, the modifications may include changes to a number and type of computing devices in the cloud environment, performance changes, such as workload, failure rates, latency, bandwidth, processing capacity, memory availability, applications running in the environment, access requests, types of data stored in the system, types of data requests

For example, applications may modify product specifications, workflows to be followed within an organization, numbers and availability of employees and teams, customer characteristics, and budget data. In one embodiment, the system stores data that specifies what data has been referenced in generative AI prompts and identifies software artifacts, such as webpages and documents generated based on the data. The system may monitor the data based on values stored in registers or tables. The system may periodically read the registers or tables to identify data that has been modified or deleted.

The system determines whether target data have been modified (Operation 212). As discussed above, the system may determine whether additions, deletions, or other modifications have been made to the target data. Detecting the changes may include, for example, periodically retrieving a current version of the target data set and comparing the current version of the target data set to a prior version of the target data set. In another example, detecting the changes may include monitoring write operations associated with the memory location that stores the target data set.

If a change is detected to the target data, the system determines if the change meets update criteria (Operation 214). Update criteria include time-based criteria, specifying when data is generated and when data is modified. Update criteria include data types. A change in values for one type of data may meet the criteria, while a change in another date type may not meet the criteria. Update criteria include a magnitude of changes, such as a number of values changed in a set of data and a degree that a value changes in a set of data.

In an example, the system executes a cosine similarity analysis between a current version of a target set of records and a prior version of the target set of records. If a similarity value does not meet a threshold, the system determines that the update criteria has been met. Where changes to a dataset include a change of values in the dataset, the system may determine if the changes to the values exceed a threshold.

The update criteria may correspond to a type of content and/or a type of software artifact that the content was generated in. For example, generative AI model may generate content based on a “year-to-date” change in values in a dataset. The system may determine if (a) the current year corresponds to the year the content was generated. If so, the system may determine that changes to the target data meet update criteria, since the year-to-date values will change. Conversely, if the generative AI model generates content directed to data generated in a previous quarter that has ended, the system may determine that changes to the target data that correspond to data generated in a subsequent quarter will not meet update criteria, since the changes to the target data would not affect the values generated in the previous quarter.

Based on determining that a change to stored target data meets update criteria, the system regenerates the content generated by the generative AI model based on the modified target data (Operation 216). Regenerating the content may, for example, include re-inputting a prompt to the generating AI model that references the memory location where the target data set is stored. Regenerating the content may, for example, include generating a new prompt to the generative AI model that references the updated version of the target data set or a memory location where the updated version of the target data set is stored.

In some embodiments, updating the content includes adding additional content to a content previously generated by the generative AI model. Additionally, or alternatively, updating the content may include modifying existing content to replace the existing content with new content.

In some embodiments, the system identifies portions of a software artifact to update based on the changed target data. For example, the system may determine that the target data is used to generate content in three independent sections of a software artifact. The system may determine that the target data is not used to generate content in two other sections of the software artifact. Accordingly, the system may generate a prompt that instructs the generative AI model to generate an updated software artifact by updating the three sections where the target data set was used to generate content and by refraining from updating the other two sections.

In some embodiments, when a system includes a link to target data in a generative AI prompt, the system further obtains metadata associated with the target data. The metadata may specify the type of target data and other characteristics of the target data.

In an embodiment, a change to target data includes the deletion of target data. If the system determines target data that was referenced in a generative AI prompt has been deleted, the system determines how to regenerate the content without the deleted data. In one example, only a portion of target data is deleted, and the system may regenerate content with the remaining portion of the target data. Additionally, or alternatively, the system may determine a data type of the deleted target data and regenerate the content by identifying related data, similar data, or data of a same data type. The system may identify the related or similar data by referring to the metadata associated with the target data set.

In some embodiments, a system notifies interested parties of changes to a software artifact. For example, an owner of a software artifact, such as a webpage or document, may request to be notified of changes in a set of target data pointed to in a generative AI prompt used to generate the software artifact. Based on the notification to the user, the system may present to the user a proposed modification to the software artifact that incorporates the changes to the data pointed to in the generative AI prompt. A user may selectively accept, reject, or modify the changes recommended by the system to the software artifact. In some embodiments, the system presents reasons for recommended changes together with the recommendations. For example, the system may generate a message stating the following: “The timeline for this project proposal was based in part on the timeline of Project QRS. Project QRS has been modified to include the new cloud service StoragePlus. It is recommended that the scope of this proposal be modified to also include the cloud service StoragePlus.”

An example embodiment is described in FIG. 2 where a system monitors a set of target data to identify changes in the target data. According to an alternative embodiment, the system accesses a set of target data based on detecting a request to access a software artifact that that includes content generated based on the set of target data. For example, a generative AI model may generate content for a document using a set of target data. If the system detects a request to view the document, the system may (a) identify the set of target data used to generate a portion of the document, (b) determine changes to the set of target data, and (c) regenerate one or more portions of the document using the generative AI model prior to transmitting or presenting the document to a requesting entity.

### 5. Industrial Applications

One or more embodiments configure the automatic triggering of a generative artificial intelligence (AI) model based on changes detected in a data set that is used by the generative AI model to generate content in a business document, such as a project proposal. An entity may generate project proposals with defined sections, including Executive Summary, Company Background, Implementation Plan, Staffing Requirements, and Timeline. A project proposal generation platform generates a prompt including instructions to generate the project proposal in a specified format. The prompt includes a pointer to a target data set to be used in the project proposal. For example, the Executive Summary section may refer to stored target data that specifies an organization's performance over the past year and a prediction regarding how a proposed project will influence the performance. The generative AI model generates content for the project proposal, including text and graphics. The system monitors the target data, such as the organization's performance data. If the system detects a change to the target data, the system may generate a new prompt to the generative AI model to generate new and/or modified content for the project proposal.

According to another example, the system configures the automatic triggering of a generative artificial intelligence (AI) model based on changes detected in a data set that is used by the generative AI model to generate software code. An entity may generate software code with a particular structure or organization. A software development platform generates a prompt including instructions to generate software code to perform a set of functions. The prompt includes a pointer to a target data set to be used to generate the software code. For example, the prompt may direct the generative AI model to generate a set of code to classify a set of target documents. The generative AI model generates content for the software code. The system monitors the target documents. If the system detects a change to the target data, the system may generate a new prompt to the generative AI model to generate new and/or modified content for the project proposal. For example, new documents may be added to the set of target data that would be classified differently than previously-existing documents. Accordingly, the generative AI model may generate a new set of software code that includes an additional document classification.

According to yet another example, the system configures the automatic triggering of a generative artificial intelligence (AI) model based on changes detected in a data set that is used by the generative AI model to generate a computing environment development plan. A computing environment management platform generates a prompt including instructions to generate a computing environment development plan, such as a plan distributing cloud resources to customers accessing a cloud environment over time. The prompt includes a pointer to a target data set to be used to generate the plan. The target data set may include (a) a set of customers, (b) data describing the customers' usage of cloud environment resources, and (c) a description of available cloud environment resources. The generative AI model generates content for the computing environment development plan. The system monitors the target data set. If the system detects a change to the target data, the system may generate a new prompt to the generative AI model to generate new and/or modified content for the computing environment development plan. For example, a change in a number of customers, an amount of cloud computing resources, and a usage rates of the customers may result in the generative AI model modifying generated content to propose a new distribution of resources allocated to customers accessing services in the cloud environment.

### 6. Example Embodiment

A detailed example is described below for purposes of clarity. Components and/or operations described below should be understood as one specific example which may not be applicable to certain embodiments. Accordingly, components and/or operations described below should not be construed as limiting the scope of any of the claims.

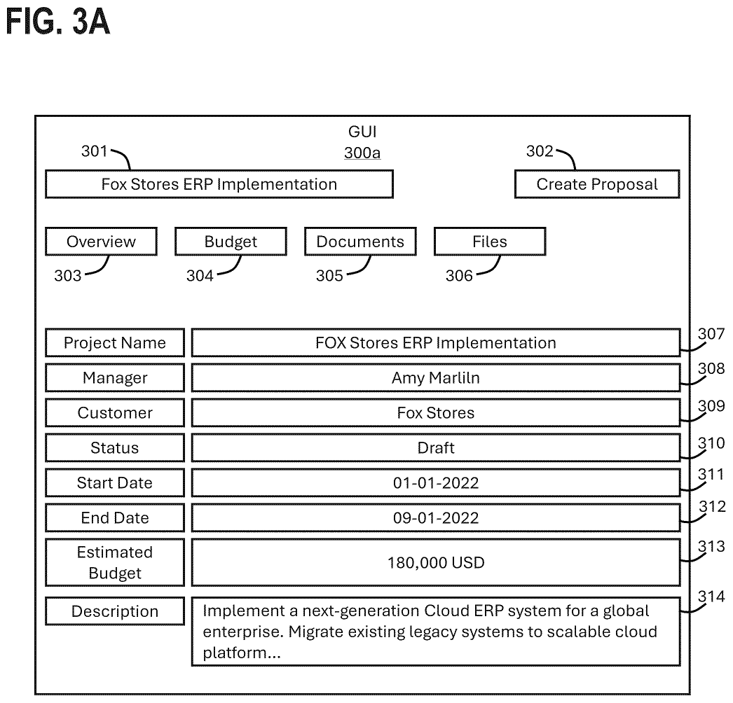

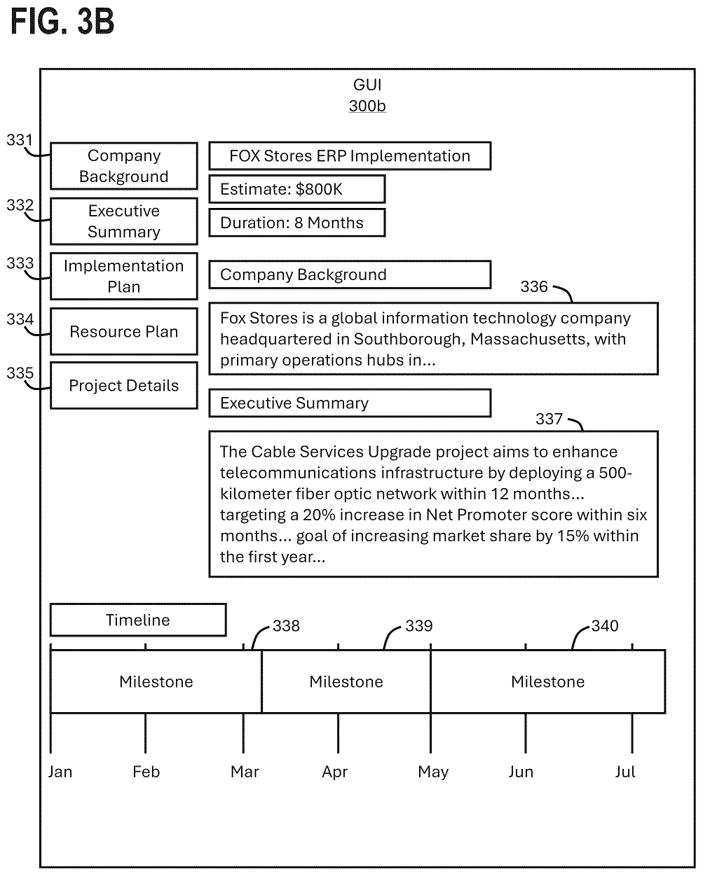

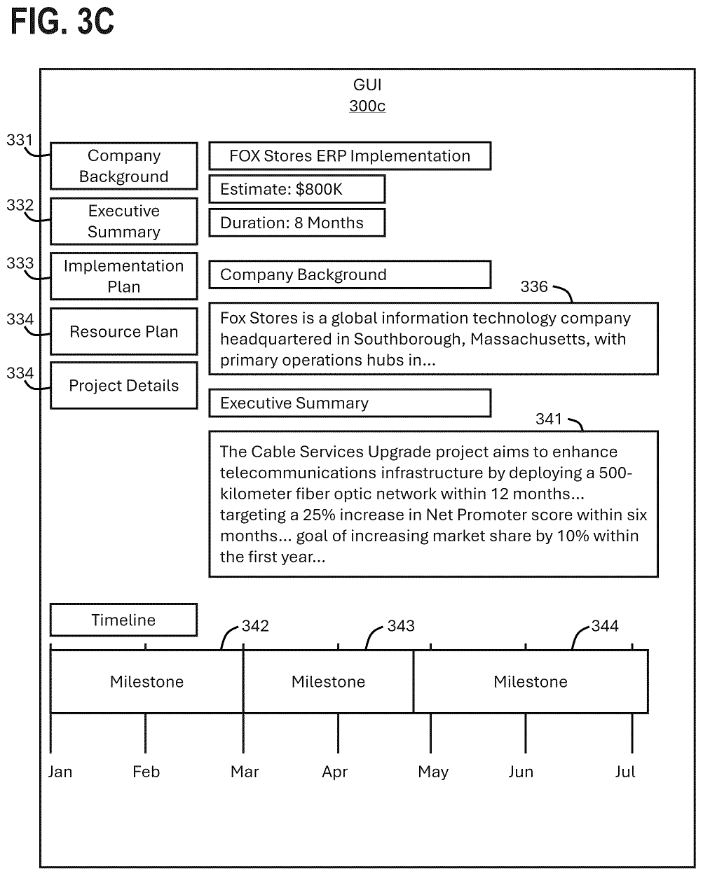

FIGS. 3A-3C illustrate an example set of GUIs 300a-300c generated by a project proposal system for generating, and regenerating, content using a generative AI model.

Referring to FIG. 3A, a GUI 300a includes fields 307-304 for specifying content associated with a project proposal. The GUI 300a includes a proposal title 301 and a set of selectable tabs, including an overview tab 303, a budget tab 304, a documents tab 305, and a files tab 306. Selecting the overview tab 303 causes a system to generate a set of fields for defining an overview of a project proposal. Selecting the budget tab 304 causes a system to generate a set of fields for defining an overview of a project proposal. Selecting the documents tab 305 allows a user to view documents associated with the project proposal, as well as adding or removing documents. Examples of documents may include financial reports, productivity reports, product specifications, and company profile documents. Selecting the files tab 306 allows a user to view files associated with the project proposal, as well as adding or removing files. A list of files may include a set of links to locations where the files are stored. Accordingly, selecting the name of a file may cause the system to follow the link to view data stored in the file. Examples of files include files describing financial data, production data, customer data, and competitor data.

A system receives instructions to a large language model (LLM) (Operation 102). The instructions may include natural language instructions for the LLM to generate content. In one or more embodiments, the instructions are received by an LLM interface platform that receives instructions to the LLM and determines whether or not to modify the instructions and/or add content to the instructions prior to transmitting the instructions to the LLM in an LLM prompt.

Fields 307-314 allow a user to enter text describing a project. In addition, a system may autofill or prefill fields based on past project proposals. A description field 314 stores text providing a brief description of a project.

GUI 300a includes a “Create Proposal” button 302. Selecting the Create Proposal button 302 causes a system to create a generative AI prompt. The generative AI prompt includes, for example, template data, data entered by a user, and links to documents and files.

FIG. 3B illustrates a GUI 300b displaying project proposal data generated based on selecting the Create Proposal button 302. The generative AI model generates a project proposal including sections defined in the prompt. The sections include Company Background 331, Executive Summary 332, Implementation Plan 333, Resource Plan 334, and Project Details 335. The system displays the section names in one region of the GUI 300b. The system displays further project detail in another region of the GUI 300b. The GUI 300b displays a Company Background section including content 336 generated by the generative AI model based on data included in the generative AI prompt. The content 336 includes text providing a background of the Fox Stores company identified as the subject of the project proposal.

An Executive Summary section includes content 337 generated by the generative AI model based on data included in the generative AI prompt. The content 337 includes figures generated by referencing data pointed to in the generative AI prompt. The data may be identified in the Files tab 306 illustrated in FIG. 3A. For example, the content includes a prediction “targeting a 20% increase in Net Promoter Score within six months . . . ” The content includes another prediction “ . . . goal of increasing market share by 15% within the first year . . . ” The generative AI model may generate the prediction values based on Net Promoter Score values stored in one file identified in the Files tab 306. The generative AI model may further generate the prediction values based on market share data stored in another file identified in the Files tab 306.

The generative AI model further generates a timeline graphic. The generative AI model identifies milestones 338, 339, and 340. The generative AI model may identify the milestones 338, 339, and 340 based on a previous project proposal included in the Documents tab 305 and based on project resource data stored in a file pointed to in the Files tab 306 illustrated in FIG. 3A.

A system identifies tasks as critical milestones based on identifying a correlation between the success or failure of the task and the success or failure of the project. In one embodiment, the system trains a machine learning model on historical sets of project data to identify tasks in a project timeline that correspond to the success or failure of the project. For example, a set of training data may include a set of tasks for a project and a particular task that incurred substantial delays, resulting in the project exceeding budget. Additionally, or alternatively, the set of training data may identify a particular task that failed, resulting in failure of the project. The machine learning model may learn to identify a task as a critical task based on determining that the success of the task has a strong correlation with the success of the project, and a failure of the task has a strong correlation with the failure of the project. The system may include the machine-learning identified critical tasks as project data. The generative AI model may generate a project proposal that identifies milestones in the project as critical milestones based on the machine-learning identified critical tasks in the project data.

Subsequent to generating the project proposal, the system monitors the stored project data for modifications to the stored project data. The system monitors the documents and files used by the generative AI model to generate the content 336-340 to detect changes to the documents and files. Based on detecting changes to the documents and/or files, the system triggers the generative AI model to regenerate content.

FIG. 3C illustrates a GUI 300c that includes regenerated content that is regenerated by the generative AI model based on detecting changes to data stored in documents and files used to generate the content 336-340. Based on detecting changes to data in one data file, the system causes the generative AI model to regenerate content 341 to describe “targeting a 25% increase in Net Promoter score . . . ” Based on detecting changes to data in another data file, the system causes the generative AI model to regenerate content 341 to describe “ . . . increasing market share by 10% . . . ”

In addition, based on changes to data stored in one or more files used to generate the timeline illustrated in FIG. 3B, the generative AI model generates a timeline illustrated in FIG. 3C with milestones 342, 343, and 344 associated with modified durations. For example, the generative AI model may detect a change in stored data to indicate an increase in personnel available to complete the project. Accordingly, the generative AI model regenerates the milestone 338 based on the modified personnel data to generate the milestone 342 that has a shorter duration than milestone 338.

In one or more embodiments, the system replaces a data file corresponding to the project proposal displayed in FIG. 3B with a data file corresponding to the project proposal displayed in FIG. 3C. In an alternative embodiment, the system stores the data file corresponding to the project proposal displayed in FIG. 3C as a new version.

In some embodiments, a system determines if a change to stored project data would affect a pending project proposal. For example, the system may determine that a change to workflow data in an organization would add a new task to a pending project proposal. The new task would result in changes to (a) personnel, (b) budget, and (c) a project timeline. The new task may also result in a change to a likelihood of success of the project. As another example, a change to a product specification to utilize a new source of goods may result in a reduced budget for a pending project proposal. As another example, a change in a structure of a company may result in a different marketing team being in charge of a product. The different marketing team may affect the time and budget allocated to a set of marketing tasks in a project proposal. As another example, the system may identify a change to the scope of a previously submitted project proposal that was referenced in the currently pending project proposal. A company may expand the scope of a project to include the incorporation of a new cloud service to a suite of services offered to customers. The system may determine that the scope of the currently pending proposal should also be modified to include the new cloud service.

According to another example embodiments, a generative AI model may generate a project proposal based in part on customer data that describes a rollout of a product to a customer. The rollout may be associated with a timeline and an indication that the rollout of the product to the customer was successfully completed. Subsequent to generating the project proposal, the company may identify a critical flaw in the rollout. The company may add a quality assurance task to a workflow specified for projects associated with the product. The system updates stored product data, such as a file pointed to in the Files tab 306 of FIG. 3A, to include modifications to the historical rollout information and to the workflows associated with the product. The system generates a new generative AI prompt to regenerate the proposal based on the changed project data. The new proposal includes a modified timeline that includes a new quality assurance task. The new proposal further includes a modified budget to account for the new task. The new proposal further includes additional text and/or graphics identifying new critical milestone. The new critical milestone may be a task that contributed to the previous failure of the rollout as a critical milestone of the project.

### 7. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGA s), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICS, FPGAS, or NPUs with custom programming to accomplish the techniques. The special-purpose computing devices may be desktop computer systems, portable computer systems, handheld devices, networking devices or any other device that incorporates hard-wired and/or program logic to implement the techniques.

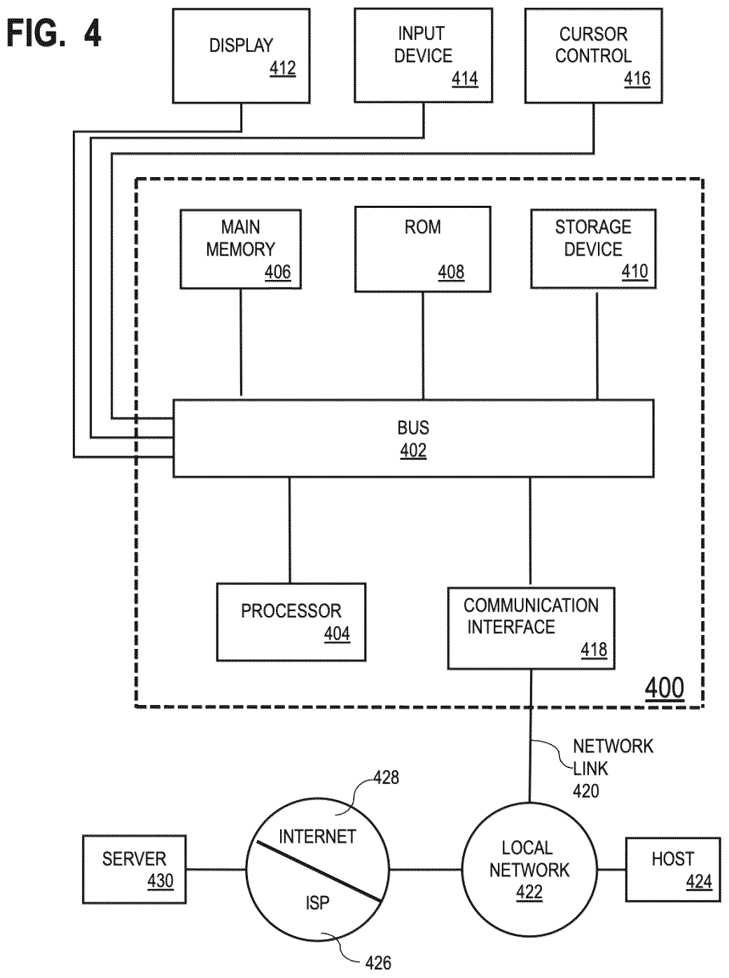

For example, FIG. 4 is a block diagram that illustrates a computer system 400 upon which an embodiment of the disclosure may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or a Solid State Drive (SSD) is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 9. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations comprising:
generating a first prompt for a generative Artificial Intelligence (AI) model, the first prompt including instructions to generate a first content based on a first set of data stored at a first location in memory;
inputting the first prompt to the generative AI model to obtain the first content that is based on the first set of data;
subsequent to obtaining the first content from the generative AI model: monitoring, in real-time, the first set of data to detect changes to the first set of data;
detecting a first set of changes to the first set of data that modify the first set of data to a second set of data; and
responsive to detecting the first set of changes: inputting a second prompt to the generative AI model to obtain a second content that is based on the second set of data.

2. The one or more non-transitory computer readable media of claim 1, wherein the first prompt (a) identifies the first location in memory storing the first set of data for use by the generative AI model and (b) does not identify the first set of data.

3. The one or more non-transitory computer readable media of claim 1, wherein monitoring the first set of data comprises monitoring write operations corresponding to the first location in memory.

4. The one or more non-transitory computer readable media of claim 1, wherein inputting the second prompt to generative AI model is further responsive to determining that the first set of changes meet content update criteria.

5. The one or more non-transitory computer readable media of claim 1, wherein the second prompt and the first prompt are (a) identical and (b) identify the first location in memory.

6. The one or more non-transitory computer readable media of claim 1, wherein the operations further comprise generating the second prompt, the second prompt identifying (a) the second set of data and/or (b) a second location in memory that stores the second set of data.

7. The one or more non-transitory computer readable media of claim 1, wherein monitoring the first set of data comprises periodically querying a database server to obtain values for the first set of data stored at the first location in memory.

8. The one or more non-transitory computer readable media of claim 1, wherein the first prompt further comprises a pointer to a second location in memory,
wherein the generative AI model executes the first prompt to generate second content using a third set of data stored at the second location in memory,
wherein the operations further comprise:
detecting a second set of changes to the third set of data that fail to meet content update criteria, and
based on determining the second set of changes fail to meet the content update criteria:
omitting, from the second prompt, instructions to update the second content.

9. The one or more non-transitory computer readable media of claim 1, wherein the first set of data is of a first data type,
wherein the first content is of a second data type, and
wherein generating the first content by the generative AI model includes converting the first set of data from the first data type into the second data type.

10. The one or more non-transitory computer readable media of claim 1, wherein the operations further comprise selectively monitoring data used to generate the first content based on a data type, at least by:
generating a first prompt to include a pointer to a second location in memory storing a third set of data; and
generating, by the generative AI model, the first content using the first set of data and the second set of data,
wherein monitoring the first set of data is based at least on determining the first set of data is of a first data type, and
wherein the operations further comprise:
based on determining the third set of data is of a second data type, refraining from monitoring the second set of data for changes to the second set of data.

11. The one or more non-transitory computer readable media of claim 1, wherein generating the first content comprises generating a first set of machine-readable code, wherein executing the first set of machine-readable code results in displaying first visual content, and
wherein updating the first content comprises generating a second set of machine-readable code, wherein executing the second set of machine-readable code results in displaying second visual content.

12. A method comprising:
generating a first prompt for a generative Artificial Intelligence (AI) model, the first prompt including instructions to generate a first content based on a first set of data stored at a first location in memory;
inputting the first prompt to the generative AI model to obtain the first content that is based on the first set of data;
subsequent to obtaining the first content from the generative AI model: monitoring, in real-time, the first set of data to detect changes to the first set of data;
detecting a first set of changes to the first set of data that modify the first set of data to a second set of data; and
responsive to detecting the first set of changes: inputting a second prompt to the generative AI model to obtain a second content that is based on the second set of data.

13. The method of claim 12, wherein the first prompt (a) identifies the first location in memory storing the first set of data for use by the generative AI model and (b) does not identify the first set of data.

14. The method of claim 12, wherein monitoring the first set of data comprises monitoring write operations corresponding to the first location in memory.

15. The method of claim 12, wherein inputting the second prompt to generative AI model is further responsive to determining that the first set of changes meet content update criteria.

16. The method of claim 12, wherein the second prompt and the first prompt are (a) identical and (b) identify the first location in memory.

17. The method of claim 12, wherein the operations further comprise generating the second prompt, the second prompt identifying (a) the second set of data and/or (b) a second location in memory that stores the second set of data.

18. The method of claim 12, wherein monitoring the first set of data comprises periodically querying a database server to obtain values for the first set of data stored at the first location in memory.

19. The method of claim 12, wherein the first prompt further comprises a pointer to a second location in memory,
wherein the generative AI model executes the first prompt to generate second content using a third set of data stored at the second location in memory,
wherein the method further comprises:
detecting a second set of changes to the third set of data that fail to meet content update criteria, and
based on determining the second set of changes fail to meet the content update criteria:
omitting, from the second prompt, instructions to update the second content.

20. A system comprising:
at least one device including a hardware processor;
the system being configured to perform operations comprising:
generating a first prompt for a generative Artificial Intelligence (AI) model, the first prompt including instructions to generate a first content based on a first set of data stored at a first location in memory;
inputting the first prompt to the generative AI model to obtain the first content that is based on the first set of data;
subsequent to obtaining the first content from the generative AI model: monitoring, in real-time, the first set of data to detect changes to the first set of data;
detecting a first set of changes to the first set of data that modify the first set of data to a second set of data; and
responsive to detecting the first set of changes: inputting a second prompt to the generative AI model to obtain a second content that is based on the second set of data.
